(19) United States
(12) Patent Application Publication
(10) Pub. No.: US 2014/0239844 A1
(43) Pub. Date: Aug. 28, 2014

(54) INTELLIGENT LIGHTING APPARATUS

(71) Applicant: AZOTEQ (PTY) LTD, (US)

(72) Inventor: Frederick Johannes Bruwer, Paarl (ZA)

(21) Appl. No.: 13/843,275

(22) Filed: Mar. 15, 2013

(30) Foreign Application Priority Data
Feb. 28, 2013 (ZA) 2013/01515

(51) Int. Cl. H05B 33/08

(52) U.S. Cl. CPC H05B 33/0863
USPC 315/292

(57) ABSTRACT

The present invention teaches self-contained lighting units which may be AC or DC powered, for example LED bulbs, and wherein the operation of said lighting units may be configured by a user through touch events or gestures, or through the use of switches or buttons. For example, operational parameters such as colour of light emitted, colour temperature, light level and an auto-off period, amongst others, may be adjusted, and stored in NVM. Use of touch swipe recognition and sliders structures for said configuration is taught. A number of intelligent luminaire embodiments are also disclosed, such as lamps with text character recognition and a wide range of connectivity options. Simple touch controlled dimmers that generate minimal EMI are described. A number of teachings on the provision of user feedback is presented. Self-contained lighting units such as LED bulbs which may be configured via IR are disclosed.

### BACKGROUND OF THE INVENTION

Solid state lighting is fast becoming the norm, mainly due to the characteristics of low power consumption relative to light output, and the long lifetime of LED's and LED bulbs. Across the globe, incandescent bulbs are being phased out, often pro-actively through legislation.

However, even though present state of the art solid state lighting units typically use power supplies with integrated control circuits, the latter does not possess the ability to directly interface with a user. Control of LED bulbs, for example, is done with dedicated control units, often physically removed from the bulb. These either control the power supplied to the bulb, or communicates in some manner, typically via a wireless link, with a power supply driving the bulb or bulbs, allowing the user to change the intensity, colour, colour temperature etc of light being emitted. Having dedicated control units increases cost and complexity of solid state lighting implementations.

In addition, due to the proliferation of smart phones and tablet computers, users see touch and proximity gestures as the de facto standard for interfacing with electronic products. This has increasingly resulted in all sorts of products incorporating touch interfaces. Solid state and other lighting units need not be excluded from this trend.

### SUMMARY OF INVENTION

The disclosure contained by PCT/ZA2012/000082, entitled Capacitive Sensing Enabled Switch Mode Power Supply and Data Transfer is hereby incorporated by reference in its entirety.

In a first embodiment, the present invention teaches a self-contained lighting unit, for example an LED bulb such as supplied by Philips or OSRAM that replaces a traditional incandescent globe for operating directly with alternating current (AC) mains power or direct current (DC) power, which have the ability to sense touch events or gestures on said unit, and which may interpret said events or gestures as user instructions for configuration setup or to control or program said lighting unit, for example to increase or decrease the amount of light being emitted, and wherein said self-contained lighting unit may incorporate an AC to DC power converter to ensure that power applied to its additional circuitry is at the correct voltage and current levels. Further, as disclosed in PCT/ZA2012/000082, a controller microchip for said power converter, with said converter that may be a Switch Mode Power Supply (SMPS), may contain touch sensing circuitry required for said sensing of touch events or gestures, and wherein said touch sensing circuitry may operate based on the measurement of a change in the capacitance of electrode structures.

In a second embodiment of the present invention, touch events or gestures on said self-contained lighting unit, for example an LED bulb, may be interpreted by said unit as user instructions to change the colour of the light being emitted by said unit.

According a third embodiment of the present invention, a user may use a swipe gesture on an AC mains or DC powered self-contained lighting unit, for example an LED bulb, to place said unit in a mode where the colour of the emitted light may be selected according the disclosed second embodiment. Alternatively, according the present invention, said swipe gesture may be used to place said lighting unit in a Red-Green-Blue (RGB) mode, and where the user may use touch on said unit to mix RGB colours to attain a preferred emitted light colour.

The present invention also teaches another embodiment where the colour temperature of the light being emitted by an AC mains or DC powered self-contained lighting unit, for example an LED bulb, may be directly adjusted by a user through touch on capacitive sensing electrodes in the bulb base, heat sink structure or on its transparent top, or through the use of discrete switches, for example a pushbutton or buttons contained by the base of said bulb. In this embodiment, timing means and counting means may be used to interpret user actions into a desired colour temperature for emitted light. For example, the duration of a touch event or gesture, or switch activation may be used to select a specific colour temperature. Or, a first touch event or gesture or switch activation may be used to start a continuous colour temperature change, and a second touch event or gesture, or switch activation may be used to halt said process at a desired colour temperature. Such selected point will then be stored in non-volatile memory (NVM). Or the number of times that a touch event or gesture, or a switch activation occur within a certain period may be used to select the desired colour temperature of light being emitted by said lighting unit, for example an LED bulb. It should be clear that according to the present invention, said user may select the colour temperature of light being emitted by said self-contained lighting unit from a number or a continuous range of values by interfacing with said lighting unit in the disclosed manner. For example, a colour temperature similar to that of an traditional incandescent bulb may be selected.

In the above embodiment description of the present invention, it will be obvious to those schooled in the relevant arts, and it is taught by the present invention, that the disclosed techniques to select a specific colour temperature need not be constrained to this parameter, but may also be used to select the amount of light, or the colour of light being emitted, or the duration of light emission by said lighting unit, for example an LED bulb.

Yet another embodiment of the present invention is an AC mains or DC powered self-contained lighting unit, for example an LED bulb, which may have a touch slider mechanism incorporated, which may be used to adjust the amount of light, the colour or colour temperature of light being emitted. To enter the mode in which a user may use said slider to adjust said parameters, said lighting unit, for example an LED bulb, may also have the ability to recognize a specific swipe event or gesture by the user on the bulb. This could help to reduce the occurrence where a user accidentally engages said slider.

According the teachings of the present invention, an embodiment can also be found in an AC mains or DC powered self-contained lighting unit, for example an LED bulb, which may have the ability change the colour temperature of emitted light due to setting of a traditional wall dimmer, for example one that is thyristor based, using a zero-cross (ZC) detect circuit in the bulb, as disclosed by PCT/ZA2012/000082.

The present invention further teaches an embodiment where an AC mains or DC powered self-contained lighting unit, for example an LED bulb, may have the ability to change the colour temperature of emitted light in response to commands communicated via toggling of a normal mains switch, as disclosed by PCT/ZA2012/000082. Or if the toggling of said mains switch is used to start a dimming process, but the user elects to abort the process, he or she may simply switch the mains switch to the off position for a sufficient period, which will result in the emitted light level being restored to maximum the next time that the lighting unit is powered.

In the above embodiments, where toggling of a wall switch or a touch gesture is used to control the duration of light emission, for example to start a gradual dimming process, the present invention teaches that each consecutive toggle or touch event or gesture may be used to increase the period until the light emission is zero. That is, toggling or touch events or gestures may be used to select a period, with said emitted light gradually fading to zero during said period. For example, a first toggle or touch event or gesture may be used to set said period to thirty seconds, and a second to set it to five minutes, a third to half an hour and so forth. Clearly the wall switch must be taken through an “OFF—ON” cycle since it must remain ON for the bulb to have any power. In this embodiment a delayed off action is initiated by the OFF/ON toggle sequence. A number of implementations are possible for example after OFF/ON, a) bulb dim to lower power level and x minutes later switch light off, b) slowly fade away to zero light over x minutes.

In another embodiment of the present invention, a touch or track pad may be used to control a luminaire, for example a desk or bed lamp. It is envisaged that said touch or track pad may be used as input device to enter said luminaire into various selection modes, using character recognition. For example, a user may trace the letter “P” on said touch or track pad, which will place the luminaire in a Power Level selection mode. Or the letter “A” may be traced, to place said luminaire in an Auto-off Period selection mode. Or the letter “T” may be traced, to place said luminaire in a Colour Temperature selection mode. Once in a particular selection mode, a user may use further tracings of letters or numbers to select a particular value or level, for example tracing a “W” to select a warm colour temperature, or a “C” for a cold colour temperature, or a “1” for power level one, and so forth. The preceding are merely given as examples of how a touch or track pad may be used to control a luminaire according the present invention, and should not be construed as limiting.

In PCT/ZA2012/000082, entirely incorporated into the present disclosure, a lamp is taught which has the ability to provide a plurality of emitted light colours, music playback, sound recognition, touch or proximity sensing and the ability to change the colour or amount of emitted light according to detected sound etc. The present invention further teaches a lamp or luminaire that utilizes a lighting unit as disclosed and which have connectivity, enabling said lamp to connect to a smart phone, tablet computer or similar. Said connectivity may be, but is not limited to, in the form of a wireless connection, or a USB connection etc. Said lamp further may have the ability to store and execute applications downloaded from the internet, and transferred to said lamp via said connectivity. It may also be possible for said lamp to directly connect to the internet via said connectivity, obviating the need for an additional device to download said applications. Said applications may result in a large number of different lamp operational schemes. For example, different applications may provide different lighting schemes where colour changes according to elapsed time based on the individual taste of users, or according to sound detected, or to the time of day, or to the date, or to the season etc. Or said applications may provide different manners of colour mixing etc. The number of possible applications possible are vast, and cannot be listed here. What is paramount is that the present invention teaches a lamp which may store and execute such downloadable applications, and which have connectivity to receive them from another electronic device.

The present invention also teaches an alternative to the above intelligent luminaire, in that the lamp or luminaire does not contain a switch mode power supply (SMPS), and does not control a lighting unit, for example an LED bulb, directly, but merely facilitates command input from a user to said lighting unit. For example, an in-line mechanical switch may be toggled to enter commands for said LED bulb. Or a three-position wheel dimmer, as described in U.S. Pat. No. 4,166,236, may be used to enter commands, where a number of sequential selections of the dimmed setting, with the corresponding half-wave rectified voltage, within a certain period, may be interpreted as a certain command etc. A switch that is normally closed and which is positioned in parallel to a diode may be used to remove half cycles when pushed to open. A further variation of the switch may be constructed to only momentarily break or open, irrespective of how long or hard the switch is pressed. During the momentarily open state, half cycles are blocked by the diode that now forms the conducting circuit. These removed half cycles are then used for power line communication. The lamp or luminaire may have a low-power reactive or dissipative power supply, for example a so-called cap-dropper supply, which only furnishes enough power to allow minimal user interface (e.g. touch sensing) circuitry and other power line communication circuitry to operate and communicate with said lighting unit, for example an intelligent LED bulb. User input into said power line communication circuitry may be via mechanical pushbuttons, touch or proximity gestures etc.

In a variation of the above embodiment, the present invention teaches that said three position wheel dimmer may be replaced by a touch and/or proximity sensing interface device which emulates the functionality of said wheel dimmer. That is, a diode may be selectively switched in series with the AC mains, or may be shorted out, or may be replaced with an open circuit, depending on the touch and/or proximity events or gestures sensed by said interface. The resulting omission of mains half cycles, or presence or absence of mains cycles in the voltage being applied to said bulb should result in 50% dimmed light emission, full light emission or no light emission by said bulb, respectively. In addition, the present invention also teaches that such omission of mains half cycles, or presence or absence of full mains cycles for specific pre-determined periods may also be interpreted by said LED bulb as specific commands for dimming, colour change, colour temperature change and so forth.

A low cost touch sensor switch with limited power level selection (dimming) functionality can be constructed in accordance with the present invention. High voltage transistors or TRIAC's may be used to switch through or block half cycles of an AC supply. In this way limited electromagnetic noise is created due to very small inrush currents and therefore the cost of snubbers and filters required to meet emission standards are reduced. When used in for example a normal desk lamp for incandescent bulbs that may later be fitted with LED bulbs, a function can be designed in to detect incandescent or LED bulbs and the functions can be adjusted accordingly. For example a very low duty cycle feature may be present for incandescent bulbs that may not work for LED bulbs and when the presence of a LED bulb is detected such feature can be disabled. The same principle may be applied to a wall switch dimmer operating with touch and offering proximity detection and backlighting activation upon proximity detection.

The half cycle to be discarded must be randomly varied in order to statistically balance the load on the mains supply.

In yet another embodiment of the present invention, a touch control unit which controls a switching element, for example a TRIAC, to allow or omit complete mains cycles for powering a lighting or an electrical motor load, the latter for example used in a fan with variable speed control, is taught. Cycles or half cycles may be omitted to reduce the amount of power supplied to a given load, for example by omitting every second cycle, only 50% power is supplied. According the present invention, by allowing or omitting complete mains cycles or half cycles from the power applied to said loads, the need for snubber and other circuits required to control switching transients to legally acceptable limits, may be reduced or completely removed, resulting in reduced cost.

Further, the present invention teaches that a switching element, for example a TRIAC, may be closed near the end of mains half cycles, to supply very little power to a load, for example. By only closing said switching element near the end of the mains half-cycle, small inrush currents are present, due to the low mains voltage level, reducing or obviating the need for Electromagnetic Interference EMI filters. This power may still be enough to power back lighting etc.

In a further embodiment an AC mains or DC powered self-contained lighting unit may have an ambient light input sensor that may be used to activate the light when the ambient light falls below a certain level or whereby the lighting unit is de-activated when the ambient light goes above a selected level. The lighting unit may also function as a night light that offers very low level of light automatically when it is dark, even when switched off (by command). The various levels of activation and de-activation may be adjusted in accordance with the teachings of this specification.

To elaborate on the manner, according the present invention, by which a user may program or control an AC mains or DC powered self-contained lighting unit, for example an LED or other lighting bulb, as disclosed previously, the following. It is envisaged, for example, that the packaging of said LED bulb may contain instructions whereby set-up or program mode of said bulb is entered by performing a swipe gesture, a long touch or a normal touch gesture or other user input mechanism directly into the bulb. Once in program mode, the user may select functionality according the following example:

One touch—colour temperature set to blue/cold white.

Two touches—colour temperature set to warm white.

Three touches—emitted light level set to 100% of maximum.

Four touches—emitted light level set to 50% of maximum.

Five touches—emitted light level set to 25% of maximum.

Six touches—emitted light level set to 8% of maximum.

Seven touches—bulb is permanently switched on.

Eight touches—an 8 hour period is allowed to elapse until an auto off event.

Nine touches—a 2 hour period is allowed to elapse until an auto off event.

Ten touches—a return to default factory settings occur.

The following parameters can all be considered for end user configuration: Power level, ON period or auto off period (On period after activation), delayed off period (time to shut off after OFF command), ambient light activation/deactivation levels, colour temperature, colour, night light function ON/OFF, UI option selection.

According the present invention, each selection by a user may be confirmed by a number of flashes. If said number of flashes required is a large number, the flashes may be split into groups (for example three), with a perceivable spacing between groups, to make counting easier. Of course the percentages, time periods etc are all just exemplary and any preferred value, amount percentage etc may be chosen. The selection feedback may also be provided via light pipes forming part of the touch sensing or button structures.

In a further embodiment, a second button, a long touch or another differentiated gesture may be used to select a specific mode or group of settings. For example, the user may hold said button in, or make said long touch, until two flashes occur, which may signify that the LED bulb, for example, is then in a power level selection mode, according the present invention. Or said button may be pressed, or long touch made, until three flashes occur, which may signify that said LED bulb is in an auto-off period selection mode. Advantageously, a much smaller number of touches may then be used to effect a selection within the selected mode.

The present invention teaches that if desired, a gradual changing colour may be presented whereby the user may select the desired colour by a touch. The colour may be colour temperature for normal (white light) or it may be predominantly white but with a soft colour tint (blue, purple, pink etc) or it may be a full colour selection within the RGB scheme.

Embodiments of the present invention where touches need to be made on the transparent dome of, for example, an LED bulb or other lighting bulb, may be facilitated with a conductive but transparent layer, for example a Polyethylene Terephthalate (PET) film with a coating of Indium Tin Oxide (ITO) or Kodak's PEDOT film.

As disclosed earlier, the present invention teaches that protection against accidental selection may be facilitated by requiring a swipe action to enter selection activation mode. A further swipe may for example be used to select a group of modes, for example auto-off period or colour temperature modes, and whereas sequential touches may be used for further detail selection within the group, according to the present invention. For example diming levels may be chosen in multiples of e.g. 20% or auto off time may be selected in units of 30 minutes.

According the present invention, ambient light may also be used as a parameter for selection. For example, the user may set an AC mains or DC powered self-contained lighting unit, for example a lighting bulb, into a selection mode in which the level of ambient light where said bulb will automatically switch on or off, may be adjusted and selected. Said selection mode may be entered according to the preceding disclosure and teachings.

In the preceding, it should be noted that, according the present invention, selections may be made with touches on alternative areas of the AC mains or DC powered self-contained lighting unit, for example an LED bulb, with said areas being isolated from mains, and non-conductive. It is even envisaged that normal pushbuttons may be used to enter selections, said alternative touch areas or push buttons being located within the heat sink structure of said bulb, for example.

The use of capacitive touch sensing to facilitate user input to control AC mains or DC powered self-contained lighting units, as taught and disclosed by the present invention, may be especially advantageous for mains lighting applications, as it may provide inherent protection against electric shock. For example, the present invention teaches that part of, or the complete heat sink structure of an LED bulb may be manufactured from plastic with good thermal conductive properties, but which isolates electrically, and wherein said touch sensing is performed across the isolation barrier formed by said heat sink plastic.

Use of light pipes to channel light from light sources, for example LED's situated on a PCB within a lighting unit, to an external periphery, for example the translucent or semi-translucent dome of an LED bulb, and to provide user guidance via said channelled light, is also hereby taught by the present specification. The light pipe may also be the electrode for capacitive sensing. The light pipe material may have a dielectric constant much higher than air or it may contain conductive material to facilitate better capacitive sensing operation. Further, said light sources, for example LED's, may be switched on for a brief period, such as after power-on, to provide user guidance. It may also be possible to use said light sources and pipes to provide an indication of elapsed burn time, for example when the product fails within a warranty period, according the present invention.

The lighting unit may be designed to automatically detect if it is working with a power line communication type dimmer. One configuration selection resulting from such detection is to prevent the lighting unit from being activated by a normal power-on cycle, this means if power is switched off (power failure) and comes back on, the lighting unit will not be activated. Optionally it can be activated if it was activated when the power failed or was switched off. This is also a parameter that may be configurable through the touch sensing UI feature.

In yet another exemplary embodiment of the present invention, an infra-red (IR) receiver may be present on said lighting units, for example LED bulbs, and used to receive commands for configuration of the lighting unit through adjustment of operational parameters, some of which have been listed during the preceding discourse. It is envisaged that users may utilize devices such as smart phones as IR transmitters to send the required IR signals to said IR receiver located on said lighting unit, with dedicated lighting unit control applications downloaded to and executed by said phones. Further, if a given smart phone does not have an IR-out port, the speaker-out port of said phone may be used to drive an IR transmitter device, wherein said application used to ensure that the signal provided to said speaker-out port is within the constraints of the port, and wherein said IR transmitter device converts the signal received from said port into the signal required by said IR transmitter to communicate said commands successfully to said IR receiver.

In another related exemplary embodiment, a so-called universal remote may be used to communicate said configuration commands via IR to said IR receiver located on said lighting unit. Such universal remotes are typically used to control a number of devices with one remote, for example a television, set-top box, audio system etc. Devices may normally be added to such a universal remote through dedicated setup and selection buttons, and the use of specific product or product category codes. Once a device is added, it may be controlled by selecting it first via a specific selection button, for example. Therefore, according the present invention, a universal remote may be configured that lighting units with IR receivers, as previously disclosed, may be added to said remote. For example, it is envisaged that a user may use said universal remote to adjust his/her audio system, and then use the same remove to adjust operation of a lighting unit as disclosed to suit the music played by said audio system.

It should be understood that in the preceding and following sections of the present disclosure, where reference is made to an LED bulb, this is merely as an example, and the present invention should not be limited to these only, but may also be relevant to a large number of other AC mains or DC powered self-contained lighting units, such traditional incandescent bulbs, or so called CFL bulbs etc.

In the present disclosure, where the term prox or proximity is used, it should be understood to mean, without placing undue limitation, that no physical contact takes place between a user and a capacitive sensing electrode, or between a user and an overlay material. Correspondingly, where the term touch is used, it should be understood to mean, without placing undue limitation, that physical contact does take place between a user and said electrode or overlay material.

Self-contained AC mains or DC powered lighting units, for example LED bulbs, as disclosed by the present invention may have a form factor similar to that of traditional incandescent or CFL bulbs, for example GU10, PAR38 or A55, and may have bases similar to that traditionally used, for example E10, E14 or E27. This may facilitate the direct replacement of, for example, incandescent bulbs by said lighting units of the present invention.

### BRIEF DESCRIPTION OF THE DRAWINGS

The invention is further described by way of examples with reference to the accompanying drawings in which:

FIG. 1 shows an exemplary embodiment of the present invention, where an LED bulb incorporates capacitive sensing ability, allowing user configuration via touch.

FIG. 2 shows an exemplary embodiment of the present invention, where an LED bulb use a plurality of capacitive sensing electrodes to detect a swipe gesture, and to allow RGB light selection.

FIG. 3 shows an exemplary embodiment of the present invention, where an LED bulb have dedicated touch areas, or use pushbuttons on the heat sink of said bulb, or on the frontal flange of the bulb, to facilitate user input.

FIG. 4 shows an exemplary embodiment of the present invention, where an LED bulb use capacitive sensing electrodes to identify swipe gestures, and for a slider type structure, to allow a more continuous adjustment of an operating parameter.

FIG. 5 shows an exemplary embodiment of the present invention, where a luminaire with an LED bulb have a track pad to facilitate user input, and where character recognition is used to determine the parameter that a user wants to adjust.

FIG. 6 shows an exemplary embodiment of the present invention, where a luminaire with an LED bulb have connectivity, and where applications to be executed by said luminaire may be downloaded from the internet via a number of interfaces.

FIG. 7 shows an exemplary embodiment of the present invention, where a luminaire utilizes an LED bulb as taught by said invention, and a 100%, 50%, 0% on-cord dimmer wheel to configure said bulb.

FIG. 8 shows an exemplary embodiment of the present invention, where a touch sensing device is used to control a series switching element for dimming in such a manner to limit emission of electromagnetic interference.

FIG. 9 shows an exemplary embodiment of the present invention, where an LED bulb contains an IR receiver, and a smart phone or universal remote may be used to configure operation of said LED bulb.

### DESCRIPTION OF PREFERRED EMBODIMENTS

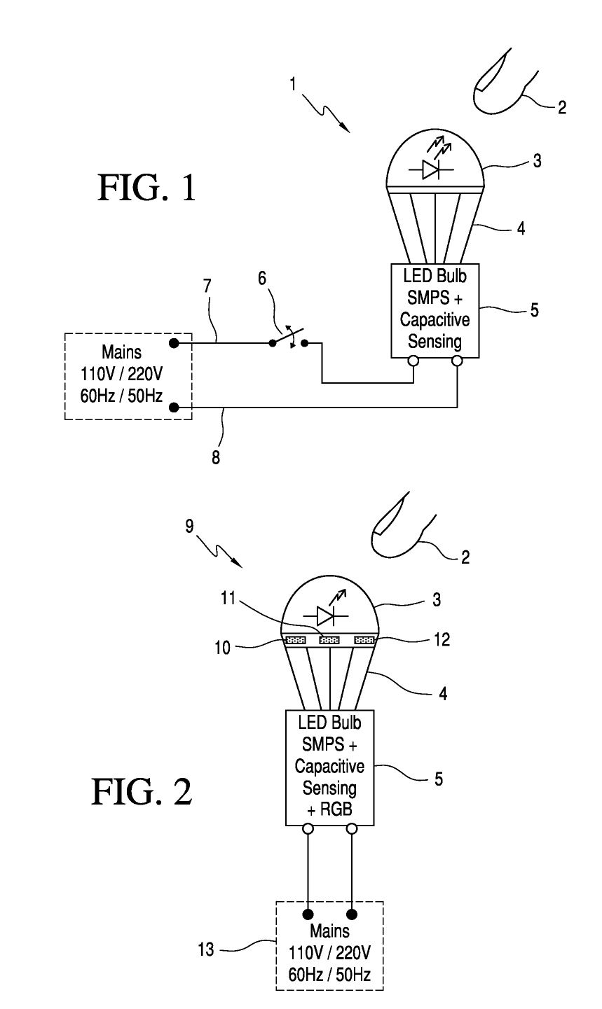

In FIG. 1, an exemplary embodiment of the present invention is illustrated. An LED bulb is shown at (1), with a transparent or semi-transparent dome portion (3), a heat sink (4) and a base (5). Said base (5) may typically be connected to the utility mains network (AC), with said connection which may be made via a mains switch (6), used to isolate either the live wire (7) or the neutral wire (8) from said bulb, or both. According the present invention, said LED bulb may have the ability to perform capacitive sensing via an interface, and use such sensing to detect user touch gestures, for example by user finger (2), where said gestures are used to configure said bulb's operational parameters. The parameters that may be adjusted via said capacitive sensing interface, according the present invention, are not limited to the following examples, but may be any one of a large number of parameters: colour of emitted light, the colour temperature of emitted light, the amount of emitted light, the duration of light emission, the period during which gradual fading of emitted light takes place or the period until the occurrence of an auto-off event.

In a typical embodiment such as that shown by FIG. 1, base (5) may contain a SMPS (switch mode power supply or voltage converter) to convert mains to the required voltage and current levels, and to control the amount of energy transferred. Further, in step with the disclosure of PCT/ZA2012/000082, a controller microchip for said SMPS may also contain touch sensing circuitry, said sensing based on the measurement of a change in the capacitance of electrode structures. A heat sink (4) is used, as is well known in the art, to remove heat due to LED element losses, with said LED's contained within dome (3).

According the present invention, toggling of mains switch (6) may also be used to adjust colour temperature, in addition to the parameters listed by, and according to the manner disclosed in PCT/ZA2012/000082, which is fully incorporated into the present disclosure.

FIG. 2 shows yet another exemplary embodiment of the present invention at (9), where three electrodes (10), (11) and (12) in an LED bulb are used for capacitive touch sensing, and to facilitate the ability of said bulb to detect a specific swipe gesture by a user's finger (2), and where said bulb is powered from mains (13). As illustrated, electrodes (10), (11) and (12) may be located on the top part of heat sink (4), or lower part of dome (3), which may facilitate ease of manufacturing and lower cost. However, the illustrated location is merely given as an example, and should not be construed as limiting. Said swipe gesture may be used as a minimum requirement to enter the LED bulb into an RGB adjustment mode, in which the user may adjust the colour of emitted light to be more red, green or blue. Said adjustment may be done via touches on electrodes (10), (11) and/or (12), or with swipe gestures that utilize two or three of said electrodes. It should be obvious that a large number of touch and/or swipe schemes or protocols to adjust colour according to the RGB scheme may be contrived that will fall within the spirit and scope of the presently disclosed invention. In addition, it is to be appreciated that any of the large number of relevant operating parameters of LED bulbs, or of other relevant lighting units, such as incandescent bulbs, or CFL bulbs, may also be adjusted, according the present invention, in a manner as described above, for example colour temperature, duration of light emission, period until an auto-off event occurs, power level, delayed switch off (i.e. stay on for a period after user switched off) and so forth.

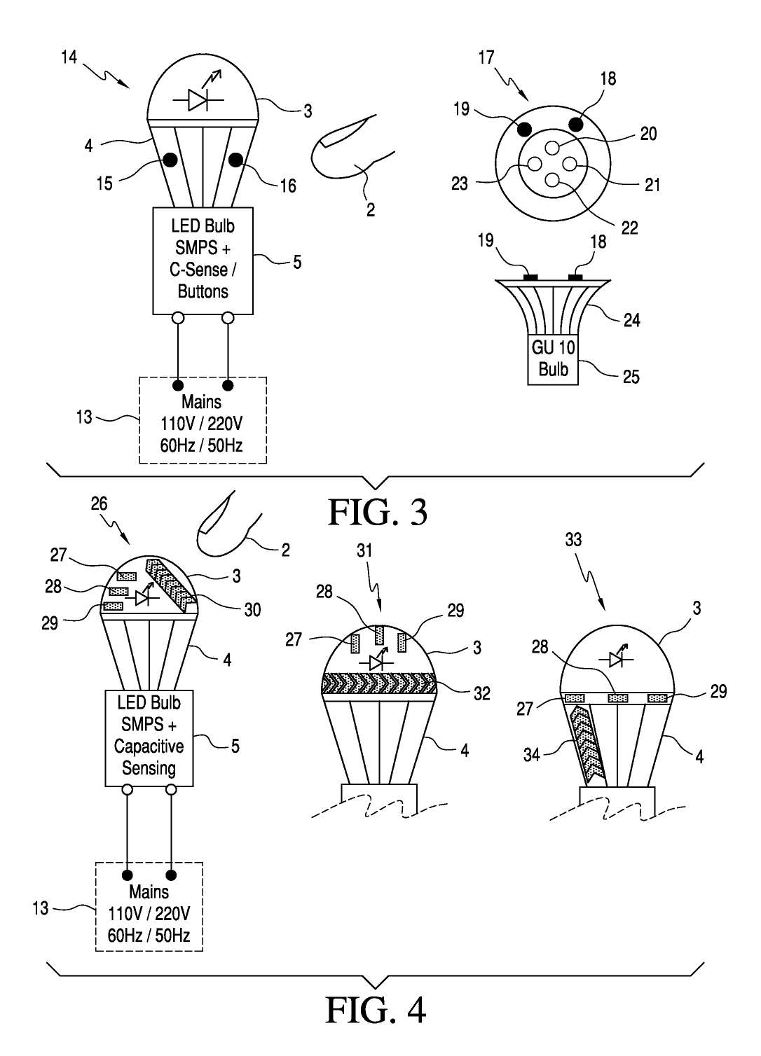

At (14) in FIG. 3, an exemplary embodiment of the present invention is illustrated where dedicated touch areas or buttons (15) and (16) are used on the heat sink or between the heat sink structures of an LED bulb to facilitate user input, for example via user finger (2), said input used to configure the bulb's operation. Said buttons may for example also be pushbuttons. To place the bulb into an adjustment mode, a user may touch area (15), or depress button (15), whichever is relevant, for a certain period. Once said period has elapsed, the entrance into said adjustment mode may be signified to the user via flashing of the light emitted by the bulb. Hereafter, the user may for example touch area (16), or depress button (16), whichever is relevant, to step through the parameter values available for selection. To exit selection mode, said user may touch area (15), or depress button (15), whichever is relevant, for a sufficiently long period, with a flash of the light emitted by said LED bulb signifying exit. The combination of button presses, number of buttons or sequence is not limited to a single switch or multiple switches, the concept is clear that a switch or switches may be used on the bulb to create a user interface through which configuration and settings of the bulb may be adjusted by the end user.

At (17) in FIG. 3, an exemplary embodiment similar to the above for a so called GU 10 type of bulb is illustrated. In these types of bulbs, and others, the heat sink (24) or body (25) of the bulb may not be accessible to the user, due to the bulb being recessed within a flat surface, showing only a flat flange that surrounds LED's, or other lighting elements, (20), (21), (22) and (23). Therefore, the present invention teaches that dedicated touch areas, switches or buttons (18) and (19) may be situated in the front flange of said bulb, with exemplary operation as described above. It is to be appreciated that operational parameters that may be adjusted according the manner illustrated by FIG. 3 includes colour of emitted light, colour temperature of emitted light, the amount of emitted light, duration of light emission and the period until occurrence of an auto-off events, amongst others. The buttons may also function as light pipes for low cost LED's mounted on a pcb contained by said bulb to assist with guiding the user during setup or configuration.

FIG. 4 shows yet another exemplary embodiment of the present invention at (26) in the form of an LED bulb with capacitive touch sensing electrodes (27), (28) and (29) contained within dome (3) of said bulb, and used to detect permissible swipe gestures of a user finger (2). These swipe gestures, if accepted, may be used to enter said bulb into an adjustment mode, wherein operational parameters as described earlier may be adjusted. Once in adjustment mode, a user may use a slider touch electrode structure, as illustrated at (30) and contained by dome (3), to select a particular value for a given parameter being adjusted. An advantage of using a slider for value selection may be its ability to provide a more continuous selection, and that its use may be fairly intuitive to many users. Further, according the present invention, the slider structure may be realized in a circular structure around the perimeter of dome (3), as illustrated at (32), with electrodes (27), (28) and (29) that are used for swipe detection being located near the apex of said dome (3), as shown at (31). If colour is adjusted, a colour chart may be positioned on the heat sink or base of a lighting unit to assist with selection. Such an arrangement may provide an extremely intuitive selection interface for users, as a user may turn their fingers along said slider (32) as if turning a knob to select a particular parameter value, according the present invention. The capacitive sensing circuitry connected to slider (32) may also operate in a manner which does not require absolute positions on said slider, but only monitors relative motion from the positions where a user finger (2), or fingers, first touches down.

At (33), an alternative placement for said slider is illustrated, which is on the heat sink (4) of said LED bulb, at (34), as an exemplary embodiment of the present invention. Electrodes (27), (28) and (29), used for swipe detection, have also been moved to the top part of heat sink (4) or lower part of the dome (3), as this may facilitate ease of manufacturing, and thus lower cost.

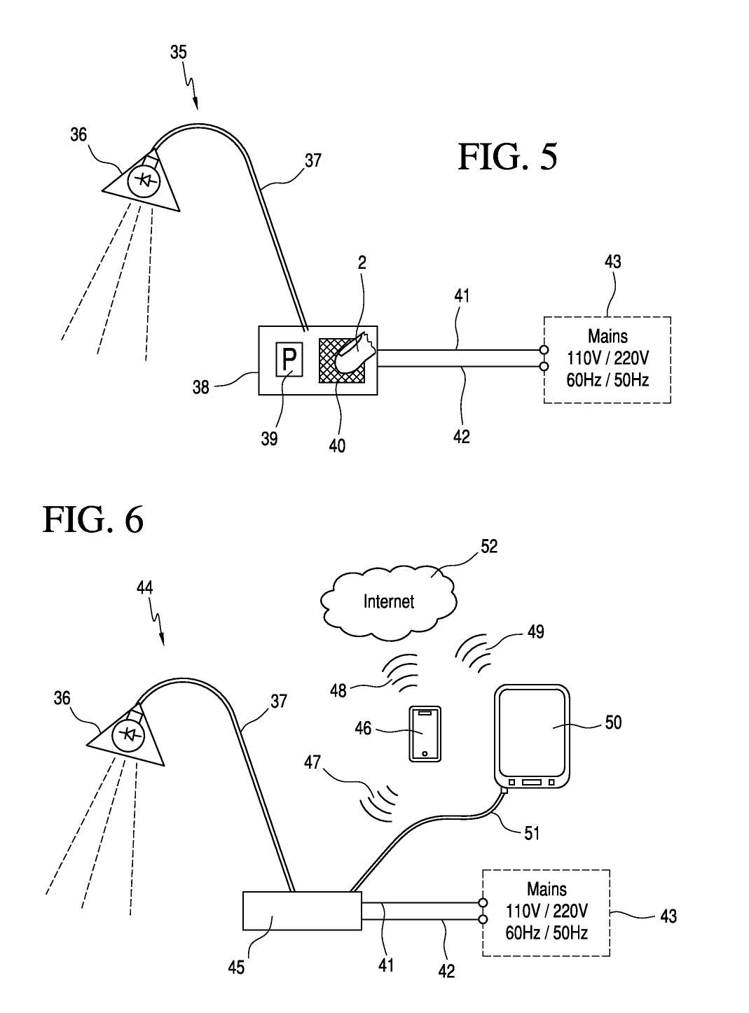

In FIG. 5, another exemplary embodiment of the present invention is presented at (35), in the form of a luminaire or lamp with a touch or track pad (40) as user interface. Purely as an example, said luminaire may be a desk lamp, with a base (38), an adjustable stem (37) and a lamp head (36) which may contain an LED bulb which may be similar to those taught in the preceding disclosures. Said base (38) will typically be connected to the utility mains network (43) via a Live wire (41) and a Neutral wire (42), and may have a SMPS to convert mains power to relevant voltage and current levels. To interface with said luminaire, a user may perform touch gestures on touch or track pad (40) with his/her finger (2), or any other relevant appendage or probe, for example a stylus. A small display (39), for example a low cost LCD display, may be incorporated into base (38), with said display assisting users to visualize their input via touch or track pad (40). For example, it FIG. 5, the user traced out the letter “P” with his/her finger. This may be interpreted by the luminaire as a command to enter a mode in which said user may select a particular power level. As an example, the user may subsequently trace out a number between 1 and 5 to select a particular power level. Or the letters “h”, “m” or “l” may be traced, resulting in high, mid or low power levels respectively. According the teachings of the present invention, a very large number of characters may be used to control said luminaire via said touch or track pad, with the possibility to use a first character to place said luminaire in a particular selection mode, and a second or more characters to make a selection. Alternatively, a user may use touch gestures, for example swipe up/down or left/right to control light level, or make a circular gesture to start an delayed auto-off sequence.

Another intelligent luminaire that also embodies the present invention is shown at (44) in FIG. 6. Once again, as an example, this may be a desk lamp similar to that described for FIG. 5. However, the luminaire in FIG. 6 has the ability to connect directly or indirectly to the internet (52). For example, base (45) of said lamp may contain circuitry allowing said connection to be a wired or a wireless connection. For a direct connection to the internet (52), said lamp may contain networking circuitry allowing establishment and use of an Internet Protocol (IP) address. Indirect connections may be made via a large number of portable or fixed computing devices, for example, a tablet computer (50) or a smart phone (46), with these connections being either wireless or wired, as illustrated in exemplary manner at (47) and (48) respectively. Said computing devices, for example smart phone (46) or tablet computer (50) may in turn connect to the internet (52) via any relevant method and hardware as held by the art of internet connectivity. In FIG. 6, wireless connections (48) and (49) to the internet (52) is shown. According the present invention, the purpose of said lamp's internet connectivity is to facilitate the download of applications by said lamp. These applications may then be stored in NVM and executed. For example, different applications may provide different lighting schemes where colour changes according to elapsed time based on individual taste of users, or according to sound detected, or to the time of day, or to the date, or to the season etc. Or said applications may provide different manners of colour mixing. As noted before, the number of possible applications may be quite vast, but if they can be downloaded to a luminaire, and stored and executed by said luminaire, it falls within the teachings of the present invention.

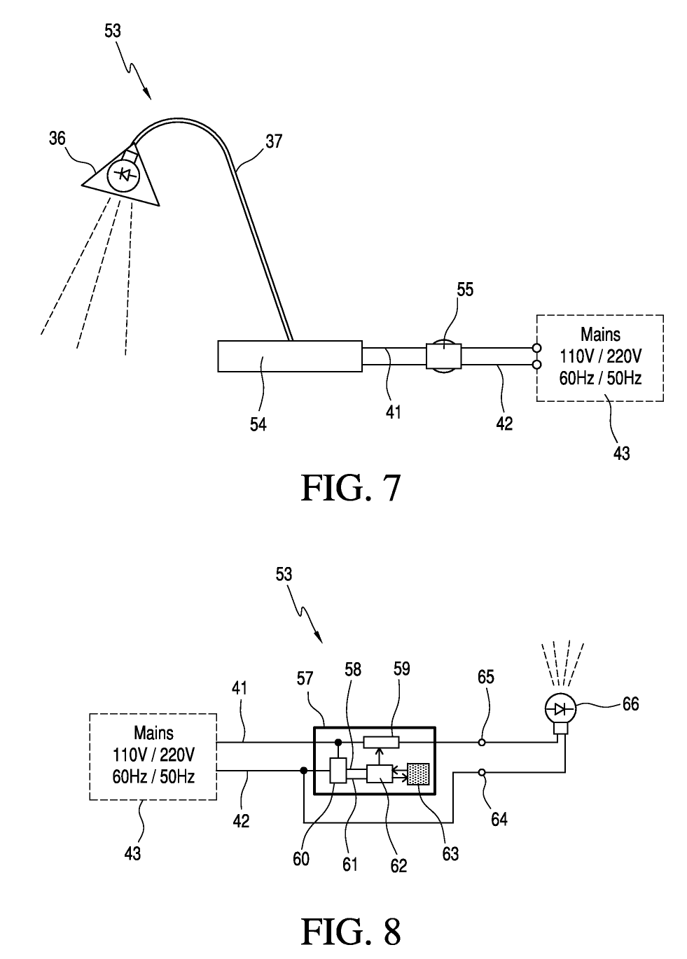

In FIG. 7, a luminaire embodiment, for example a desk or bed lamp, of the present invention is shown which utilizes a three state dimmer wheel (55) on live wire (41) and neutral wire (42) to configure operation. The three state dimmer wheel is similar to those that have been commercially available for many years, and to that described in U.S. Pat. No. 4,166,236. Nominally, such dimmers allow three settings, maximum power, 50% power or off. These settings are attained, respectively, by connecting the mains directly to the load, by connecting the mains via a half wave rectifier to the load, or not connecting the mains to the load. However, according the present invention, such a dimmer wheel may also be used in a different manner to configure the operation of said luminaire at (53) which is powered by mains (43). A user may use said dimmer wheel (55) to apply 100% , 50% and 0% of mains power in a particular sequence to said luminaire. Either circuitry in base (54), or a lighting unit, for example an LED bulb, similar to that described earlier in the present disclosure, and contained by lamp head (36), may detect said sequence of alternate mains power levels, and interpret it as a particular command, for instance to enter a particular selection mode, whereupon subsequent sequences of 100%, 50% and 0% of mains power being applied are used to select particular values for a given operational parameter. Operational parameters may be any one from a large possible number, a few example of which are: colour of light emitted, colour temperature of light emitted, the amount of emitted light, the duration of light emission, the period during which a gradual fading of emitted light takes place, the period until the occurrence of an auto-off event or a delayed switch off period (i.e the lamp stays on for a period after user switched off). Said operational parameter value may then be stored in NVM, and the lamp may use it to adjust its operation, either automatically, of after dimmer wheel (55) is used in a particular manner, similar to that described above, to exit said selection mode and to return to normal operation. This is akin to the toggling of a mains switch described in PCT/ZA2012/000082, and referred to earlier in the present disclosure.

FIG. 8 presents a related exemplary embodiment at (56). Device (57) is a touch sensitive dimming device, and may be used to control the amount of power delivered to a load, via terminals (64) and (65), which may be a lighting load, for example an LED bulb (66), or any other pertinent load, for example an incandescent bulb, a motor, a heater element and so forth. Device (57) may comprise a power supply (60), which may be, for example, a capacitive dropper type supply, and used to furnish power, which may be a small amount, via interconnects (58) and (61) to a controller (62). Said controller (62) may have the ability to sense user touch or proximity gestures via a sense electrode structure (63), and to control series switching element (59), which may be a TRIAC, or other high voltage semiconductor based switches, for example MOSFET's. Device (57) may have the ability to accurately sense the ZC points of the AC mains voltage (43), as supplied via interconnects (41) and (42). When a relevant touch or proximity gesture is sensed, controller (62) may control series switching element (59) in such a manner that for example, every second mains half cycle is blocked, with switching of element (59) occurring as close as is possible to said ZC points, to minimize electromagnetic interference generation. Such blocking of mains half cycles may result in LED bulb (66) only emitting 50% of nominal light. Further, according the present invention, device (57) may be instructed by a user via touch and/or proximity events or gestures on or near sensing electrode structure (63) to go into an ultra-low power FITD mode, wherein series switching element (59) only allows the first or last few per cent of a mains half cycle to be applied to said LED bulb (66), resulting in it being dimly lit, thus performing a FITD function. In such a FITD mode, due to the low value at which said AC mains voltage is being switched, generation of electromagnetic interference should be limited, according the present invention. Such a FITD mode may also be realized with an incandescent bulb as load, although the voltage and current levels required may be different. The present invention teaches that device (57) may have the ability to discern between incandescent and LED bulbs, for example through current versus time and voltage measurements, and adjust said control of series switching element (59) accordingly. This may allow a user to used touch sensitive dimming device with either bulb type.

Essentially all switching needs to be close to the zero cross point to prevent electromagnetic noise generation. Blocking of two half cycles will remove a full AC power cycle with the advantage of a balance load on the mains.

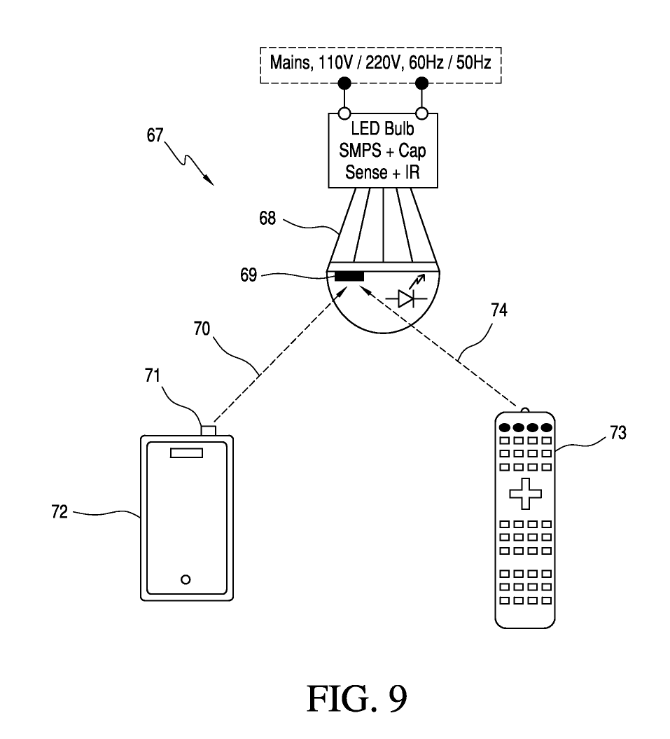

Another exemplary embodiment of the present invention which may enable a user to directly configure a self-contained lighting unit, in this case an AC mains power LED bulb (68), is presented at (67) in FIG. 9. Said bulb contains an IR receiver (69), allowing a user to adjust its operational parameters, as listed and discussed before during the present disclosure, through the use of devices which can transmit relevant IR signals (70) and (74), for example a smart phone (72) or a universal remote (73) respectively. If a smart phone does not have IR transmission capability, an adaptor (71) may be utilized, wherein said adaptor plugs into the audio-out port of said phone, for example, and converts audio-out signals into the required IR signals. In this case, an application may be running on said phone which allows a user to select and adjust said bulb operational parameters, and wherein said application then routes data reflecting such selection and adjustment to said audio-out port in a relevant format for reception by adaptor (71). Alternatively, a universal remote (73) may be used to adjust the operation of said LED bulb (68), according the present invention. Said remote may be set up in such a manner that LED bulbs may be controlled without interference to other devices also controlled by the remote, and vice versa, as is common with universal remotes. This would require said LED bulb (68) to incorporate the necessary FW required to decode universal remote messages, to avoid unintended control of said bulb. In both cases, that is the use of a smart phone or use of a universal remote, feedback may be provided to said user during lighting unit configuration via visible indicators, such as flashing of emitted light, or via audible indication, for example via a buzzer contained by said LED bulb (68).

1. A self-contained lighting unit comprising a AC to DC power converter circuit, said unit having an ability to detect user touch events or gestures, and wherein a user may configure said unit through said touch events or gestures, and wherein said configuration is performed through a selection and adjustment of one or more operational parameters.

2. The lighting unit of claim 1, wherein said unit is in a form factor suitable for replacement of incandescent bulbs.

3. The lighting unit of claim 2, wherein said unit is AC (mains) powered, and wherein said power converter circuit is a switch mode power supply and a microchip that controls the switch mode power supply also comprises capacitive sensing circuitry to detect the touch events or gestures.

4. The lighting unit of claim 1, wherein touch events and touch gestures are detected using capacitive sensing circuitry, and wherein said configuration is stored in non-volatile memory.

5. The lighting unit of claim 3, wherein the operational parameters may be any one or more selected from the following group:
amount of emitted light
colour of emitted light
colour temperature of emitted light
duration of light emission
period until occurrence of an auto-off event
delayed off period
ambient light levels at which said lighting unit is activated / deactivated
night light function status.

6. The lighting unit of claim 3, wherein said unit utilizes light emitting diodes to facilitate light emission and wherein the colour temperature of the lighting unit is adjusted between cold white and warm white.

7. The lighting unit of claim 4, wherein a plurality of capacitive sensing electrodes is used to recognize a specific swipe gesture or sequence of touches by said user, and wherein said recognition is used as a qualification that allows said unit to enter a parameter selection, configuration or adjustment mode.

8. The lighting unit of claim 5, wherein touch events or gestures on one or on a combination of a single or a plurality of electrodes can be used to select or adjust one or more of the operational parameters.

9. The lighting unit of claim 5, wherein Infra Red communication (IR) is also used to enter said unit into an operational parameter selection mode, or to select values for said operational parameters.

10. The lighting unit of claim 1, wherein a user can use one or a plurality of push-buttons to configure said unit by entering it into an operational parameter selection mode, or to select values for said operational parameters, wherein said values are stored in non-volatile memory, and wherein the operational parameters may be any one or more selected from the following group:
amount of emitted light
colour of emitted light
colour temperature of emitted light
duration of light emission
period until occurrence of an auto-off event
delayed off period
ambient light levels at which said lighting unit is activated / deactivated
night light function status.

11. The lighting unit of claim 8, wherein said unit utilizes light emitting diodes to facilitate light emission.

12. The lighting unit of claim 3, wherein light pipes are used to transfer light from a source within said unit to a periphery visible to said user, and wherein said light thus transferred are used to provide guidance to said user on the configuration of said unit.

13. The lighting unit of claim 12, wherein said light pipes are used as capacitive sensing electrodes, or wherein said light pipes facilitate capacitive sensing by providing improved coupling to a sensed object due to a dielectric constant value for said light pipes.

14. The lighting unit of claim 8, wherein light pipes are used to transfer light from a source within said unit to a periphery visible to said user, and wherein said light thus transferred are used to provide guidance to said user on the configuration of said unit.

15. The lighting unit of claim 3, which is powered from AC mains, and which have the ability to detect a specific sequence of toggling of a mains switch connected to said unit, and wherein said detection is translated into a change in the colour temperature or the power level of emitted light.

16. An AC mains or DC powered luminaire, wherein a touch or track pad is used to facilitate user input and control of said luminaire, and wherein recognition of specific characters traced by said user on said touch or track pad are used to select an adjustment mode for a specific operational parameter, and wherein further recognition of specific characters are used to adjust said operational parameter.

17. The luminaire of claim 16, wherein a display is used to assist said user with the visualization of characters being traced on said touch or track pad.

18. The luminaire of claim 17, wherein lighting applications are downloaded directly from the internet, or from a smart phone, tablet computer or another computing device, wherein said download is done using a wired or wireless connection, and wherein said smart phone, tablet computer or another computing device downloaded said application from the internet.
